(19) United States
(12) Patent Application Publication
(10) Pub. No.: US 2006/0236039 A1
(43) Pub. Date: Oct. 19, 2006

(54) METHOD AND APPARATUS FOR SYNCHRONIZING SHARED DATA BETWEEN COMPONENTS IN A GROUP

(75) Inventor: Amit Golander, Tel-Aviv (IL)

Correspondence Address: INTERNATIONAL BUSINESS MACHINES CORPORATION;DEPT. 18G, BLDG. 300-482, 2070 ROUTE 52, HOPEWELL JUNCTION, NY, 12533, US

(73) Assignee: INTERNATIONAL BUSINESS MACHINES CORPORATION, Armonk, NY (US)

(21) Appl. No.: 10/907,868

(22) Filed: Apr. 19, 2005

(51) Int. Cl. G06F 13/28

(52) U.S. Cl. 711/147

(57) ABSTRACT

A method and system for use by a cache-less component contained in a group of two or more components each having access to shared data stored in a shared segment of memory connected to the components, at least one of which is cache-less. Synchronization of the components in the group is assured by detecting memory accesses performed by components in the group. Upon detecting that any one of the components accesses data in the shared segment of memory, a state associated with the data is set to a first value.

### FIELD OF THE INVENTION

This invention relates to synchronization of shared data between components in a group. More specifically, the invention relates to synchronization of shared data between components in a group, wherein at least one of the components in the group is cache-less.

### BACKGROUND OF THE INVENTION

Synchronization of cache lines has long been a problem in the art. For example, cache coherency protocols are known, that are important to consistent operation of multi-processors, where a non-shared cache of a shared memory segment exists. According to the MESI (Modified, Exclusive, Shared, Invalid) protocol, for example, every cache line is marked with one of the four following states: ‘M’ (Modified) Indicates that this cache line was modified and therefore the underlying data is no longer valid; ‘E’ (Exclusive) Indicates that this cache line is only stored in this cache and has not yet been changed by a write access; ‘S’ (Shared) Indicates that this cache line may be stored in other caches of the machine; and ‘I’ (Invalid) Indicates that this cache line is invalid.

A cached component that control its cache line using the MESI protocol, typically uses the known per se MESI state diagram illustrated in FIG. 1.

Other simpler or more complex protocols are known in the art for cache coherency control, such as the MOESI (Modified, Owner, Exclusive, Shared, Invalid) protocol or the MSI (Modified, Shared, Invalid) protocol.

If the multi-processors are coupled via a shared bus, each one of them can snoop on this shared bus in order to detect when other processors affected changes to the cache line. Therefore, a coherence protocol used by multi-processors connected via a shared bus is referred to as a “centralized cache coherence protocol”.

“Distributed cache coherence protocols” are also known in the art and are used mainly in medium to large multi-processor environments where there is no shared bus that is coupled to every processor, such as a directory-based cache coherence protocol. A directory-based cache coherence protocol requires that all the processors whose cache lines are to be synchronized will be connected by an interconnection infrastructure. A directory is added to each shared memory segment, each directory being responsible for tracking the state of each cache block. The directory can communicate with its respective processor and memory over a common (shared) bus, it can have a separate port to the memory, or it can be part of a central controller (a “directory server”).

In addition to tracking the state of each cache block, processors that have copies of the block should be tracked too. Basically, the states and transitions for the state machine that is required to track each copy can be similar or analogous to what are used in the centralized coherence protocols, such as the snooping coherence protocols.

For example, U.S. Pat. No. 6,658,539 (“Super-coherent data mechanisms for shared caches in a multiprocessing system”, published 2003) discloses a method for improving performance of a multiprocessor data processing system having processor groups with shared caches. When a processor within a processor group that shares a cache snoops a modification to a shared cache line in a cache of another processor that is not within the processor group, the coherency state of the shared cache line within the first cache is set to a first coherency state that indicates that the cache line has been modified by a processor not within the processor group and that the cache line has not yet been updated within the group's cache. When a request for the cache line is later issued by a processor, the request is issued to the system bus or interconnect. If a received response to the request indicates that the processor should utilize super-coherent data, the coherency state of the cache line is set to a processor-specific super coherency state. The individualized, processor-specific super coherency states are individually set but are usually changed to another coherency state (e.g., Modified or Invalid) as a group.

Synchronization of memory access has been a problem dealt with in the art also with regards to components including no cache. US 2002/0078270 (“Token based DMA”, published 2002) for example, discloses a method and system for accessing a shared memory in a deterministic schedule. US 2002/0078270 describes a system that comprises a plurality of processing elements and a system I/O controller where each processing element and system I/O controller comprises a DMA controller. The system further comprises a shared memory coupled to each of the plurality of processing elements where the shared memory comprises a master controller. The master controller may issue tokens to DMA controllers to grant the right for the associated processing elements and system I/O controller to access the shared memory at deterministic points in time. Each token issued by the master controller grants access to the shared memory for a particular duration of time at a unique deterministic point in time. A processing element or system I/O controller may access the shared memory upon the associated DMA controller relinquishing to the master controller the token that grants the right to access the shared memory at that particular time. The master controller may then reissue the relinquished token back to the DMA controller associated with the processing element or system I/O controller that accessed the shared memory if at a future designated time, e.g., 128 ns from the completion of the access to the shared memory, there does not exist a higher prioritized request, e.g., refresh the shared memory, to access the shared memory at that future designated time. The reissued token grants the right to access the shared memory at the future designated time.

The synchronization problem is particularly severe when one or more hardware components have to share data in a shared memory segment.

For example, in U.S. Pat. No. 6,182,165 (“Staggered polling of buffer descriptors in a buffer descriptor ring direct memory access system”, published 2001), a microcontroller implements a buffer descriptor ring direct memory access (DMA) unit that polls buffer descriptors when in idle mode. This polling is to determine whether software has set up a buffer or group of buffers transmission and transfer ownership of those buffers to the DMA unit. To reduce interrupt latency and bandwidth occupation, the polling of these buffer descriptor ownership flags is staggered for the DMA channels. For example, if eight DMA channels are implemented, the polling of their buffer descriptors can be distributed throughout a 1.28 millisecond polling interval.

However, existing memory access synchronization schemes require processing time and are characterized by delay intervals, as indicated, for example, by the 1.28 ms intervals that are disclosed by U.S. Pat. No. 6,182,165. It is also appreciated that polling, or token issuing, for example, consumes processing resources and therefore affects load on components employing such mechanisms.

There is a need in the art, thus, for an efficient memory access synchronization mechanism.

### SUMMARY OF THE INVENTION

It is therefore an object of the invention to provide a method and apparatus for an efficient memory access synchronization mechanism.

A specific object of the invention is to provide a method and apparatus for synchronizing shared data between components in a group, at least one of which is cache-less, which allows for efficient memory access, are subject to reduced delay intervals and consume less processing resources than hitherto-proposed approaches.

The present invention provides a method for use by a cache-less component contained in a group of two or more components at least one of which is cache-less, for synchronizing between the components in said group, each component in said group having access to shared data stored in a shared segment of memory, the components in the group and the shared segment of memory being interconnected, the method comprising:

detecting memory accesses performed by components in said group; and

when detecting that any one of the components in said group accesses data in said shared segment of memory, setting a state associated with said data to a first value.

The invention further provide an apparatus for use by a cache-less component contained in a group of two or more components at least one of which is cache-less, for synchronizing between the components in said group, each component in the group having access to shared data stored in a shared segment of memory, the components in the group and the shared segment of memory being interconnected, the apparatus comprising:

a detector for detecting memory accesses performed by components in said group and indicating when any one of the components in said group accesses said shared data; and

a state setting module coupled to the detector and being responsive to any one of the components in said group accessing data in said shared segment of memory for setting a state associated with said data to a first value.

### BRIEF DESCRIPTION OF THE DRAWINGS

In order to understand the invention and to see how it may be carried out in practice, a preferred embodiment will now be described, by way of non-limiting example only, with reference to the accompanying drawings, in which:

FIG. 1 illustrates the MESI state diagram (prior art);

FIG. 2 is a block diagram illustrating a computer system, according to one embodiment of the invention;

FIG. 3 is state diagram illustrating state modifications of shared data respective of a component within the system of FIG. 2, according to one embodiment of the invention;

FIG. 4 is a block diagram illustrating an apparatus for synchronizing shared data between components in a group, according to one embodiment of the invention;

FIG. 5 is a block diagram illustrating an apparatus for synchronizing shared data between components in a group, according to another embodiment of the invention;

FIG. 6 is a flowchart illustrating synchronization between components in a group of two or more components, at least one of which is cache-less, according to one embodiment of the invention; and

FIG. 7 is a flowchart illustrating synchronization with shared data, according to one embodiment of the invention.

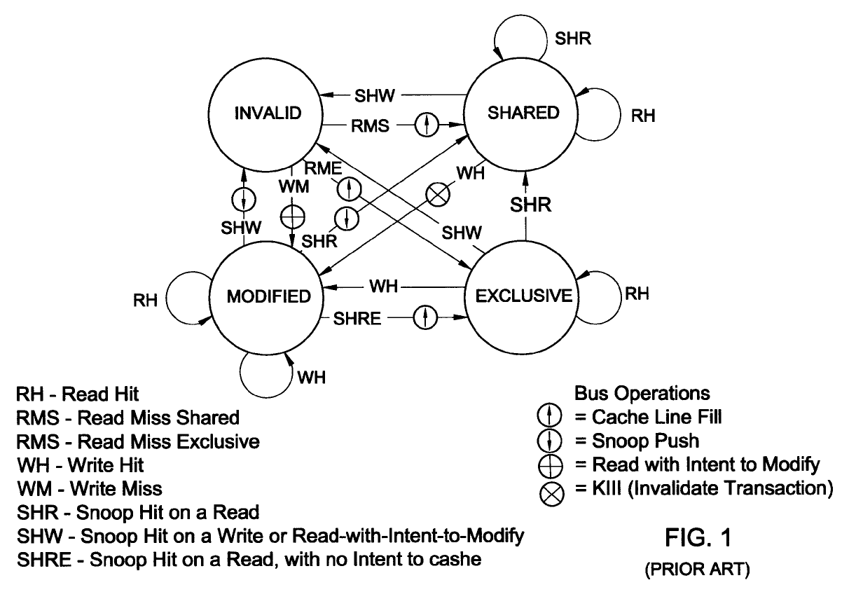

### DETAILED DESCRIPTION OF EXEMPLARY EMBODIMENTS

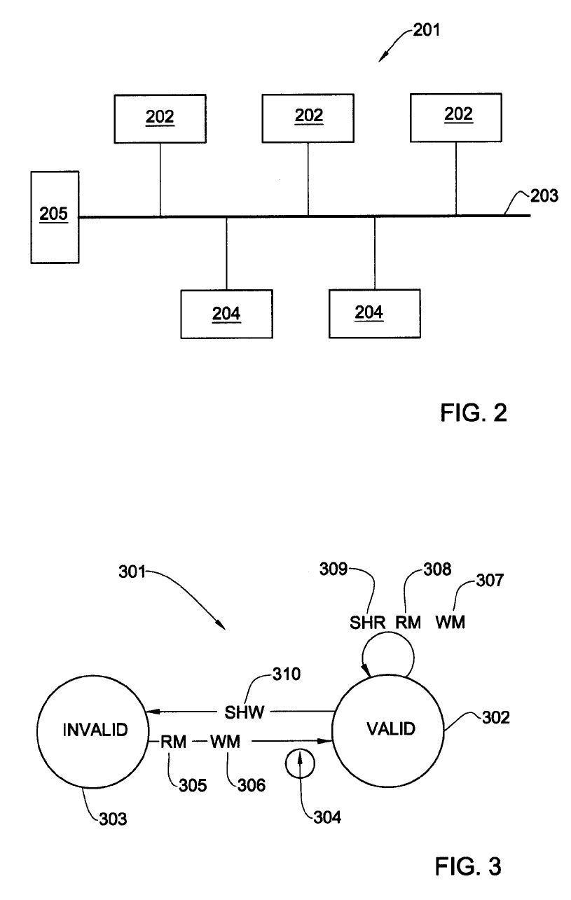

FIG. 2 is a block diagram illustrating a computer system 201, according to one embodiment of the invention. The system 201 includes cached components 202, such as a processor or a Central Processing Unit (CPU), that are coupled, via a bus 203 with cache-less components 204, such as a DMA controller. It is noted that all the cached components 202 and all the cache-les components 204 have access to the bus 203.

The system 201 includes also a memory 205, or at least a segment thereof, that is accessible by the cached components 202 and by the cache-les components 204. Cached components 202 and cache-les components 204 that have access to a certain segment of memory are referred together as “components”. In addition, a memory device or a segment of memory that is accessible by two or more components is referred to as a shared memory or as a shared segment thereof.

It is noted that in FIG. 2 the system 201 includes several cached components 202 (three in this example) and several cache-les components 204 (two in the figure). However, this is non-limiting and any number of cached components and cache-les components can apply. Furthermore, the system 201 can include only cache-les components 204 and no cached processors 202. Generally, the system 201 includes a group of at least two components of which at least one is a cache-less component 204.

For example, sometimes a processor can perform non-cached memory access, referred to, hereinafter, as direct memory access. Such a processor that performs direct memory access is considered as a cache-less component 204 regardless of the fact that this processor is able also to perform cached memory access. That is, the system 201 can include, e.g., two components, of which at least one performs direct memory access. Furthermore, the system 201 can include a single cache-enabled processor. A computerized procedure, such as a computer program that uses the processor's cache operates on this processor. Another computerized procedure, which does not use the cache, also operates on this processor. The cache using procedure is considered as a cached component 202, while the other computerized procedure is considered as a cache-less component 204. That is, the system 201 can include a single processor operating two or more computerized procedure, out of which at least one in a cache-less component 204.

A person versed in the art can appreciate that frequently two or more components are mapped to a shared segment of memory, or more specifically, to shared data in the shared segment of memory. For example, one or more cached components 202, such as a program operating on a cached-enabled processor, may access data stored in the memory 205, while at the same time one or more of the cache-less components 204, such as a DMA controller, is mapped to access this same data structure for the purpose of data transfer.

It is also appreciated that components can access shared data for reading and/or for writing. If two or more components are mapped to the same shared data while one of them modifies the data stored therein, the other components should become aware that the shared data was changed, allowing them to re-read the shared data before performing any operation thereon.

It was previously demonstrated, in the background of the invention, that if the two components are cached components, snooping coherence protocols (including MESI, MOESI, MSI and others) and/or other cache coherence protocols can be applied in order to keep the content of the caches coherent with the content of the shared data. However, according to the invention, a coherency procedure is beneficial also to a system such as system 201, that includes at least one cache-less component.

In the MESI protocol, for example, there is a system of cached components that snoop on a commonly accessible bus. Each component in the system indicates to itself whether the state of its cache-line is Modified, Exclusive, Shared or Invalid, as known to those versed in the art. It will be appreciated that snooping is characterized by substantially no delay intervals. That is, the snooping cached component identifies memory access performed by other cached components with substantially no delay. In addition, snooping consumes less processing resources than other methods such as polling.

According to the invention, in a system 201 including two or more components (of which at least one is a cache-less component), two states can be used, namely “valid” and “invalid”, in order for a component to indicate the state of its respective shared data.

For example, after a first component writes data to a shared memory, and as long as no other component modifies this data, the first component can consider this data as valid. However, if another component modifies the shared data, the first component should consider the shared data is invalid, that is, the first component should be made aware that any information it held relating to the shared data before the other component modified it may be invalid now.

According to the invention, all the components 202 and 204 in the system 201 have access to shared data in a memory device 205 via the same bus 203. Thus, each component that is mapped to the shared data can snoop on the bus 203, in order to detect when any other component in the system 201 accesses this shared data.

If writing data to the shared memory is considered to be an atomic operation, then immediately after or together with modifying the content of the shared data, i.e., before any other component can access this data too, the first component can indicate that the state of its respective shared data is valid. According to a different embodiment, if the first component reads the content of shared data, and if reading is also considered to be an atomic operation, then immediately after or together with reading the content of the shared data, the first component can indicate that the state of its respective shared data is valid.

When the first component detects (while snooping) that another component has accessed the shared data, the first component can indicated that the state of its respective shared data is invalid.

Furthermore, it is appreciated that sometimes other components can access the shared data, yet leaving it valid to the first component, or more generally, not modifying the state of the shared data respective of the first component. For example, this occurs when other components access the shared data for reading. Thus, when the first component detects (while snooping) that another component requests a read-only access to the shared data, it is not required to change the state of its respective shared data.

The state diagram 301 of FIG. 3 illustrates states modifications of shared data respective of a component within a system 201, according to one embodiment of the invention. As was previously explained, the state of the shared data can be one of “valid” 302 or “invalid” 303. It is realized that before performing any operation on its respective shared data, if the state of the shared data is invalid, the component can re-read 304 the data. (In the MESI protocol this is equivalent to what is commonly referred to as filling the cache line and/or read with intent to write). Alternatively, a component can write data to the shared memory without reading it first. The component is allowed to do so even when being aware that the content of the data was changed (i.e., when the state is invalid). This is non-limiting and other embodiments are allowed as well. For example, according to an alternative embodiment, a component can set its state respective of shared data to be valid only when writing data (306) to the shared memory. According to this latter embodiment reading data (305) does not trigger state modification from invalid to valid.

The state diagram illustrates that if the state of a component's respective shared data is invalid 303, then after reading 305 (in the MESI protocol this is equivalent to what is commonly referred to as “read miss”, or more shortly RM including RMS and/or RME) or writing 306 (in the MESI protocol this is equivalent to what is commonly referred to as “write miss”, or more shortly WM) data thereto, the component sets the state to valid 302. However, if the state is already valid 302, then when the component writes content (307) to the shared data or reads data therefrom (308) it can leave the state intact without setting it. Similarly, if the snooping component detects 309, while in a valid state 302, that another component reads the shared data with no intent to modify it, i.e., the other component accesses the shared data with read only permission (in the MESI protocol this is commonly referred to as “snoop hit on read”, or more shortly SHR), the state stays valid.

On the other hand, if a component, whose respective shared data state is valid 302, detects while snooping that another component writes data or reads data with intent to modify it 310, i.e., the other component accesses the shared data with write intention (in the MESI protocol this is equivalent to what is commonly referred to as “snoop hit on write”, or more shortly SHW), the component sets the state to invalid 303.

As before, the embodiment illustrated in the figure is non-limiting and alternative embodiments are allowed. For example, according to a different embodiment, when the component detects that another component accessed the shared data for reading (SHR), it changes its respective state to invalid.

Hereinafter, the scheme allowing memory access coherency control in accordance with the state diagram of FIG. 3 is referred to as a “VI protocol” (VI stands for Valid and Invalid). It is noted that the terms “invalid” and “valid” are non-limiting and any other terms can be used instead, such as “modified” and “shared”, or “suspect” and “assured”. Generally, the terms “first value” and “second value” are used, respectively, and the VI protocol is referred to, therefore, as a “two state protocol”.

Turning back to the system 201 that includes a group of two or more components at least one of which is a cache-less, it should be realized that in accordance with one embodiment of the invention, cached components 202 as well as cache-less components 204 can operate in accordance with the two state protocol for synchronizing shared data between the components in the group.

Alternatively, according to a different embodiment, if the system 201 includes cached and cache-less components, at least some of the cached components 202 can employ “foreign cache coherence protocols”, such as the MESI protocol, while the cache-less components 204 can employ the two state protocol. Such a system is referred to as a “combined system”. A cached component that employs a known cache coherence protocol is referred to as a “foreigner cached component”, and a component (cached or cache-less) that employs the two state protocol is referred to as a “two state component”.

In a combined system, when a foreigner cached component accesses shared data, the snooping two state components detect the memory access (snoop miss on read or snoop miss on write) and operate in accordance with the description provided above (with reference to FIG. 3), regardless of the scheme employed by the foreigner cached component.

On the other hand, when a two state component in such a combined system accesses the shared memory, the foreigner cached components detect its memory accesses regardless of the protocol employed thereby, and operate in accordance with their respective coherence protocols.

The description above provides exemplary embodiments of the two state protocol. Those skilled in the art will appreciate that additional states can be added to the protocol, therefore giving rise to a multi-state protocol. Yet, the multi-state protocol includes a first state and a second state, together with additional states. The cache-less component sets a state to an appropriate one of the included states in respect of each item of shared data, when it detects that other components access the shared data. For example, according to one such embodiment, when the cache-less component detects that any one of the components in the group accesses the shared data with read-with-intention-to-write permission, it can set the state to a third state, such as “modified”. Only when any one of the components truly writes data, is the state associated with the data set to the first value, such as “invalid”.

After reading the description above, and remembering that in FIG. 2 a group of components is coupled via a bus 203, a person versed in the art will appreciate that a cache-less component operating in accordance with the embodiments illustrated so far operates in accordance with a “centralized synchronization protocol”.

However, it was mentioned in the background of the invention that apart from centralized cache coherence protocols, distributed cache coherence protocols (such as directory-based cache coherence protocols) are also available and are used, for example, for tracking cache coherence in distributed groups of components, i.e., when there is no bus that couples the components on the group.

Thus, it should be appreciated that according to another embodiment, a cache-less components contained in a distributed group of two or more components can operate in accordance with a “distributed synchronization protocol”, that is, like a cached component the cache-less component can have a directory responsible for tracking the state of each shared data in a shared segment of memory. When the directory detects (in a method known per se) that the data in the shared segment of memory changes, or when it detects access to the data, it provides a message to the cache-less component, notifying it of the access. When the component receives the message, it can respond thereto by setting a state associated with the data to a first value. Thus, within the context of the description and the appended claims, the term “detecting” embraces not only active detection by the component that shared data has been accessed, but also embraces any other form of detection that informs a component of memory accesses.

In addition, it should be noted that the synchronization described in the embodiments above is not limited to synchronization of shared data. For example, a cache-less component can use access to shared data in order to trigger a certain operation such as calling a certain function. According to this example the component can be mapped to shared data in a shared segment of memory. The shared data can be, for example, one or more bits, one or more bytes or any other structure or size of shared data. When a cache-less component operating in accordance with an exemplary embodiment detects (by snooping, by receiving a directory message or by any other way) that another component accesses the shared data, it sets the respective state to a first value. It should be appreciate that according to this embodiment the first value can be, for example, an address of a function. Thus, the component can call this function. That is, synchronization according to this latter embodiment means calling a function when detecting access to data in a shared segment of memory. Yet, this example is non-limiting, and any other synchronized operation is allowed instead, such as pausing etc.

It is also noted that sometimes one component can be mapped to more than one data item in the shared segment of memory. In this case a cache-less component can have more than one state, wherein each state is associated with one datum.

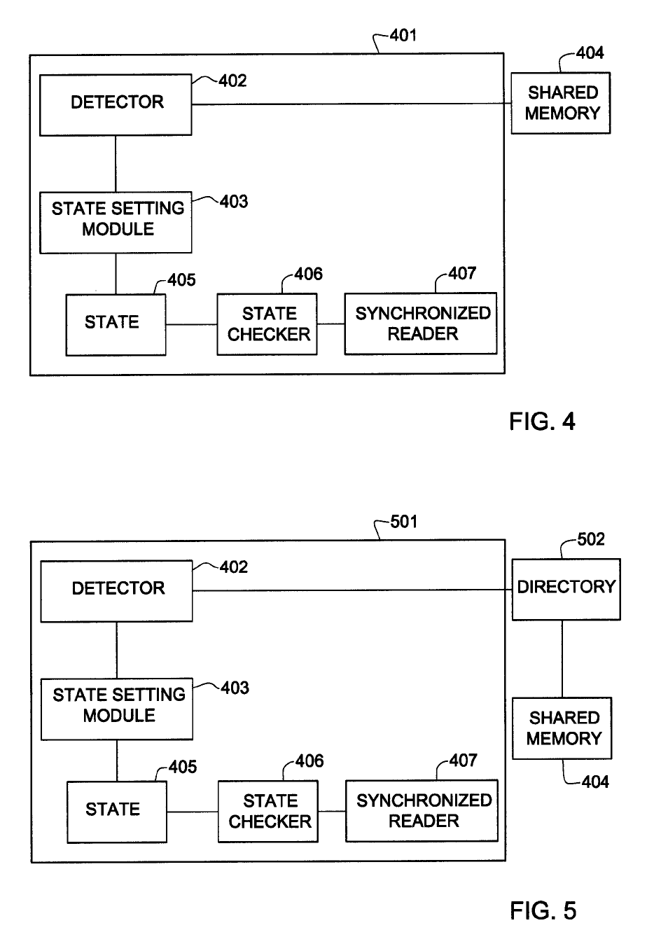

FIG. 4 is a block diagram illustrating an apparatus 401 for synchronizing shared data between components in a group, according to one embodiment of the invention. The apparatus 401 includes a detector 402 and a state setting module 403 coupled thereto. The detector is also coupled to a shared memory 404 or to a segment thereof.

The detector 402 detects when other components accesses shared data in the shared memory 404, and provides an indication when access is detected. For example, see 310 (with reference to FIG. 3). The state setting module 403 sets a state 405 accessible thereto to a first value (such as “invalid”) in response to an indication provided by the detector 402, that another component in the group had accessed the shared data.

It is noted that the apparatus 401 can be used, for example, in a cache-less component, for synchronizing between the cache-less component and other components that together form a group of components, such as the group illustrated in FIG. 2. The other components in the group can be cache-less or cached components.

According to one embodiment of the invention the detector 402 is coupled to the shared memory 404 via a shared bus. FIG. 5 shows an apparatus 501 according to another embodiment wherein components performing equivalent functions are identified by the same reference numerals as shown in FIG. 4. Thus, the apparatus 501 includes a detector 402 and shared memory 404 that are coupled via a directory 502, as was previously explained. The apparatus 501 also includes a state setting module 403, similar to that shown in FIG. 4, for setting a state 405 accessible thereto. In practice, the shared memories 404 in FIGS. 4 and 5 may be different types of memory and the detectors 402 in FIGS. 4 and 5 may be different types of detector, but since they perform equivalent functions in both cases they are identified by the same reference numerals in both figures.

The apparatus 401 and the apparatus 501 include both a state checker 406 that has access to the state 405, and a synchronized reader 407 coupled thereto. The state checker 406 checks the state 405 of the shared data and provides indication if the state is different than a second value, such as “valid” in the two state protocol. In response to indications provided by the state checker 406 and/or before performing operation on the shared data, the synchronized reader 407 synchronizes the component with the shared data and resets the state to the second value. According to one example the synchronized reader 407 synchronizes the component by reading data from the shared memory. According to a different embodiment the synchronized reader 407 synchronizes the component by performing any other applicable operation such as calling a function, as was previously explained.

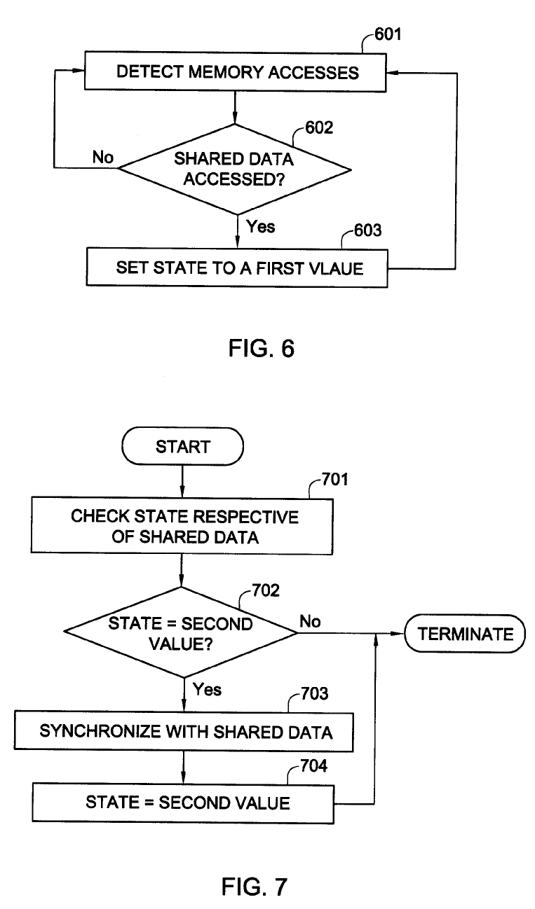

FIG. 6 is a flowchart illustrating synchronization between components in a group of two or more components, at least one of which is cache-less, according to one embodiment of the invention. In 601 a cache-less component detects memory accesses performed by components in the group. When in 602 the component detects that any one of the components accesses shared data in a shared segment of memory, in 603 it sets a state that is associated with the shared data to a first value, that flags it as possibly invalid. In an alternative embodiment, instead of setting the state it is possible to generate an indication that the state should change to the first value.

FIG. 7 is a flowchart illustrating synchronization with shared data, according to one embodiment of the invention. Before performing operations on shared data, in 701 the state respective of the shared data is checked. If in 702 the state is different than a second value that flags it as valid, in 703 the component synchronizes with the shared data stored in a shared segment of memory, e.g., by reading data from the shared memory, and in 704 the state is set to the second value.

The present invention has been described with a certain degree of particularity, but those versed in the art will readily appreciate that various alterations and modifications may be carried out, without departing from the scope of the following claims.

What is claimed is:

1. A method for use by a cache-less component contained in a group of two or more components at least one of which is cache-less, for synchronizing between the components in said group, each component in said group having access to shared data stored in a shared segment of memory, the components in the group and the shared segment of memory being interconnected, the method comprising:
detecting memory accesses performed by components in said group; and
when detecting that any one of the components in said group accesses data in said shared segment of memory, setting a state associated with said data to a first value.

2. The method according to claim 1 wherein:
the components in the group and the shared segment of memory are coupled by a bus; and
detecting memory access includes snooping on said bus.

3. The method according to claim 1 wherein:
the components in the group and the shared segment of memory are coupled to a directory; and
detecting memory access includes receiving from said directory a messages indicative of the access.

4. The method of claim 1, further comprising:
before performing operations on the respective shared data of said cache-less component, checking the state of said shared data; and
if said state is different than a second value, synchronizing the component with said shared data and resetting said state to the second value.

5. The method of claim 1, further comprising:
checking the state of said shared data in said cache-less component; and
if said state is equal to the first value, synchronizing the component with said shared data and resetting said state to a second value.

6. The method of claim 1, wherein said setting is performed only when detecting that any one of said components accesses said shared data with write intention.

7. The method of claim 1, wherein said setting is performed only when detecting that any one of said components accesses said shared data for writing data thereto.

8. The method according to claim 1, wherein said group includes at least one cached component.

9. The method according to claim 1, wherein said group includes only cache-less components.

10. The method of claim 8, wherein at least one of the cached components employs a foreign cache coherence protocol.

11. The method of claim 10, wherein the foreign cache coherence protocol is one of a centralized coherence protocol and a distributed coherence protocol.

12. The method of claim 11, wherein the centralized coherence protocol is one of a group including a MESI protocol, a MOESI protocol and an MSI protocol.

13. An apparatus for use by a cache-less component contained in a group of two or more components at least one of which is cache-less, for synchronizing between the components in said group, each component in the group having access to shared data stored in a shared segment of memory, the components in the group and the shared segment of memory being interconnected, the apparatus comprising:
a detector for detecting memory accesses performed by components in said group and indicating when any one of the components in said group accesses said shared data; and
a state setting module coupled to the detector and being responsive to any one of the components in said group accessing data in said shared segment of memory for setting a state associated with said data to a first value.

14. The apparatus of claim 13, wherein:
the components in the group and the shared segment of memory are coupled by a bus; and
the detector is adapted to detect memory accesses by snooping on said bus.

15. The apparatus of claim 13, wherein:
the components in the group and the shared segment of memory are coupled to a directory; and
the detector is adapted to detect memory accesses by receiving from said directory messages indicative of the access.

16. The apparatus of claim 13, further comprising:
a state checker for checking the state of said shared data and providing indication if the state is different than a second value; and
a synchronized reader coupled to the memory checker and being responsive to indications received by said memory checker for synchronizing the component with said shared data and resetting said state to the second value.
